(19) United States
(12) Patent Application Publication
(10) Pub. No.: US 2017/0201526 A1
(43) Pub. Date: Jul. 13, 2017

(54) System and method for protecting sections inside a file

(71) Applicant: APPDOME LTD., Tel Aviv (IL)

(72) Inventors: Avner Yehuda, Ramat Gan (IL); Omer Schory, Givataim (IL)

(73) Assignee: APPDOME LTD., Tel Aviv (IL)

(21) Appl. No.: 14/941,618

(22) Filed: Nov. 15, 2015

(51) Int. Cl. H04L 29/06

(52) U.S. Cl. CPC H04L 63/105; H04L 63/20; H04L 63/0428

(57) ABSTRACT

Today's methods for protecting the contents of a file enable a user to encrypt the whole file and protect its content from others. This means that for a company with employees at different categories which need to get access to certain sections in the document, multiple categories, multiple version of the document need to be generated with different encryption schemes this which will complicate the document generation, distribution and update at the corporate server

The present invention will allow inclusion of encrypted sections in the file and by using the metadata layer the standard application may be instructed to ignore these sections. Hence a single document may exist with reading capabilities set per employee category and the sections always encrypted thus simplifying the document generation and distribution at the corporate server.

### BACKGROUND

Data protection is possible by using encryptions—a well encrypted data can be read only by users with the appropriate decryption software with the knowledge of the right keys.

An encrypted data is a combination of all types of characters—and therefore it cannot be properly read by most file processing software tools (Word, Acrobat Reader, Excel).

If there are several sections need protection for different usage rights for different types of users, than there needs to be a file generated per user type with the encryption of the appropriate sections and a file without the protected data for users with no rights.

For example, a file may include confidential technical information. A certain group of employees may have full usage rights, another one will be able to read, but not to modify and another to read but not to transfer.

Under the exiting methods it is impossible to have a single file allowing this.

### SUMMARY

The purpose of the present invention is to allow a single file generation and distribution by a company server with different access levels to different sections to different employees This of course cane be generalized for all types of users.

The present invention suggests a system and a method for easily protecting sections inside a file. A single file will be generated for all types of users.

This is especially important for companies with employees working on mobile computing devices, such as smart phones or tablets. It is expected that employees will have a range of systems—where some are privately own.

Different types of employees may have different rights for accessing protected sections on each of their devices.

This system and method apply to all common file types, such as .pdf, .docx, .xlsx, media, text . . .

The central system application can select different sections in the file as defined by a ‘protection policy’ for it, based on guidance from a person or an automated rule base.

The protected section can be either encrypted of just not shown. If encrypted, there will be a data section, which the standard applications cannot handle with a standard setting, as it will not contain standard characters. Encrypted data may result in data which cannot be presented using standard file processing applications, such as Word or Acrobat

The protection policy will refer to the type of data, which is important for the file preparation (technical, marketing, business), and user type (for example is this a design engineer of a marketing person) which is important for the decryption system.

It can also include conditions—such as a location and time

The invention will allow encrypted data to be stored in a file in a way that will allow reading the file without decrypting it and ignoring these sections.

There will be two types of users—with or without permission.

With permission, the user may have different levels of file usage capabilities—read/write/view/delete/transfer etc.

With permission the file will be decrypted and all permitted sections shown to the user. It is possible that only a portion of such sections will be decrypted for this user without permission the decrypted portions will be ignored and not presented, or with a message of inability to present certain data.

After applying the protection scheme the file can still be opened, viewed and edited by the default common applications corresponding to the file type (e.g. Acrobat Reader for .PDF, Microsoft Word for .doc, etc)

Protected sections are either not shown, or an informative message is shown instead, e.g. ‘This section is encrypted and therefore not shown’.

### BRIEF DESCRIPTION OF THE DRAWINGS

FIG. 1 describes the file preparation method

FIG. 2 describes the file reading and decryption method

FIG. 3 describes the full system

### DETAILED DESCRIPTION

The file preparation will be done in a central system based on ‘protection policy’.

What type of data needs to be protected?. The policy will determine:
The encryption method and its characteristics (potentially no encryption at all)
Whether the encrypted part should be hidden, or a message should be presented, in which case the content of the message is specified
The conditions for protecting/encrypting a certain section
The conditions for unblocking/allowing access to protected/encrypted sections
User identities
Date and time
Location
Application being used to access the data
Device from which data is being accessed
Environmental conditions—which apps are installed/running when accessing the data
Device capabilities (has camera, has PIN code etc.)
More . . .

Using the protection policy sections will be automatically selected for encryption.

The policy may be different per a protected section.

The unblocking needs to be done by a special application, which will decrypt the encrypted sections and restore the original data.

The protection method works as follows:

The file types mentioned above are commonly structured using interleaved sections containing metadata and content. The metadata includes information about the content of the section, its length, and more.

The corresponding standard processing applications are built to identify the metadata sections and present the protected content sections accordingly. If the file includes a non-standard metadata section, the content section is ignored due to metadata.

The protection method is using the above characteristics as follows:
When a section inside a file needs to be encrypted, the original metadata section is kept as is but the protected content section is replaced by either blanks or a message, according to the protection policy definition
A new section is added, containing a proprietary metadata section and a content section, which includes the original section encrypted. The metadata can instruct the application just to ignore the data in this section. Therefore, a standard application can be used which will be able to go over a file with sections it cannot handle—otherwise the application, especially a smart phone application will crash/result in an file open error.

The metadata can include information on the type of data.

This method can also be used for generic purposes—not just for data protection.

Just changing the metadata of a file can cause a change in the way it will be presented without modifying the data.

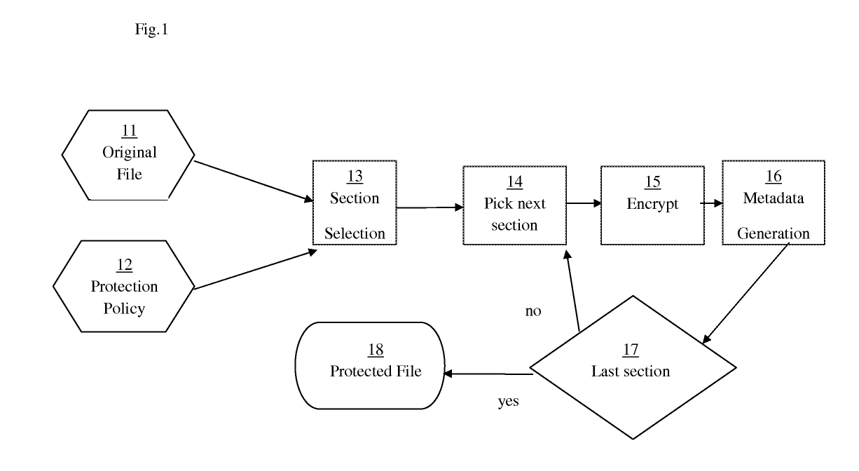

The file preparation system is shown in FIG. 1

System 1 is the central system. This can be a corporate server or a corporate network, with many computers on it, but under the tight control of the company IT.

The protection policy may reside in a central system or may be distributed to the computing devices, it may be different from one computing device to the other.

A protection policy 12 will be prepared; this can be done under the guidance of a person or based on a set of rules. It will include the rules described above.

The original file 11 and the protection policy will be the inputs for the protection software. A section selection application 13 will automatically select sections.

Multiple sections can be selected. A section type will be prepared per section. (for example customer contact list)

In step 14 a section will be picked.

In step 15 it will be encrypted.

In step 16 metadata will be added to it. It will be based on the file type (meta data for Word, metadata for PDF) and will cause the relevant application to ignore the data. It will also include the data type.

This section will be added to the file. The original section will be deleted.

In step 17 it will be asked if this is the last section.

If no, the flow will go back to step 14.

If yes, in step 18 the protected file is ready.

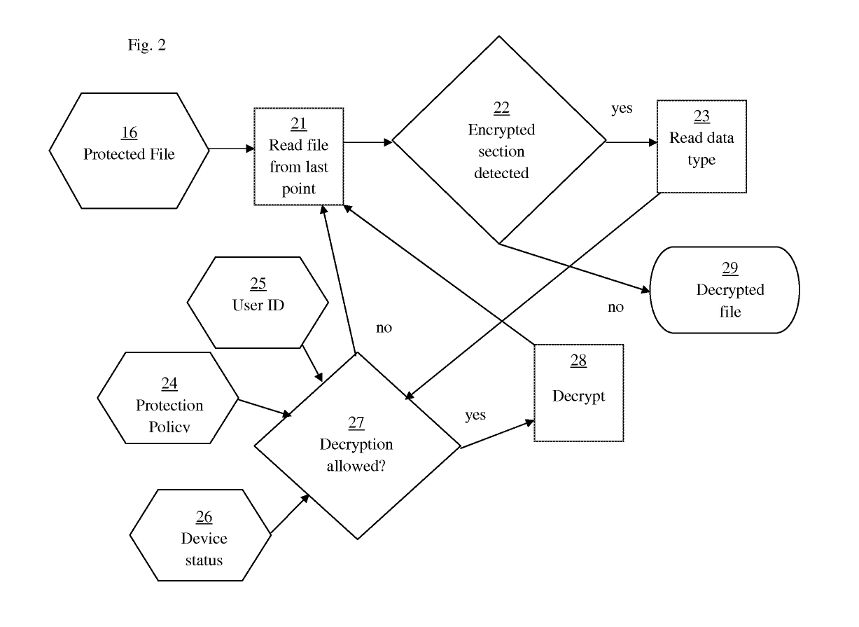

FIG. 2 describes the reading and decrypting flow for end devices with a decryption application.

End devices can be PCs, notebooks, smart phones, tablets and IOT enabled devices.

For end devices, without a decryption application, the file will be read by the standard application and the protected sections will be ignored.

For end devices with a decryption application, in step 21 data will be read either from the last point reached in the file (the end of a session). For the beginning, it will be from the start.

In step 22 it will be asked if an encrypted section is detected. If no, the decrypted file is ready in step 29. If yes, in step 23 the data types in the meta data will be extracted.

From there it will go to step 27.

In step 27 it will be decided if a decryption of this section is allowed based on the data type 23, the protection policy 24, the user ID 25 and the device status (location and time for example).

If the answer is no the flow will move back to step 22.

If the answer is yes, the data will be decrypted in step 28 and the decrypted data added to the file.

From there it will move back to step 22.

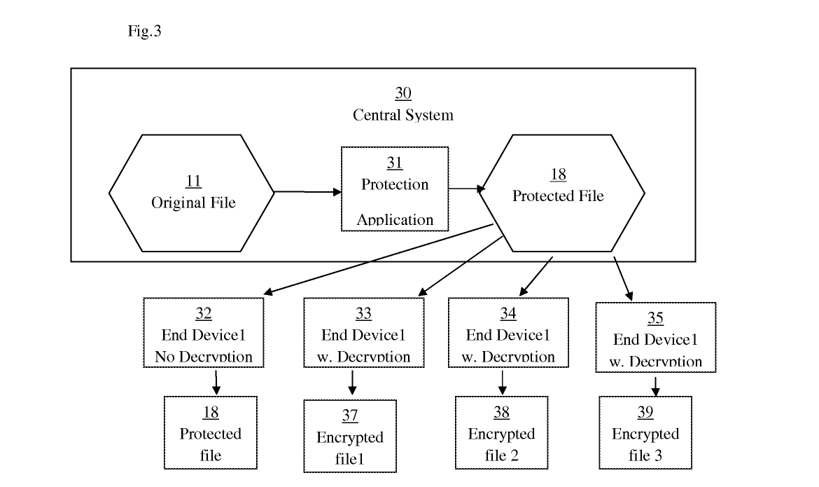

FIG. 3 is showing a full system

Central system 1 incorporates the original file 11, the protection software 31 and the protected file 18.

It will be connected to 4 end devices—the number of potential end devices is infinite.

The protected file 18 will be sent to all such devices.

In this example, Device 1 32 had no decryption software and it will just use the protected file 18 sent to it and will read the file with the protected sections ignored.

Device 2, 33, will have a decryption application. Based on its ID and the device status certain sections will be decrypted and file 2 37 will be prepared.

Device 3 and 4 (34 and 35) will also have a decryption application—but since they have a different ID and their end device status is different sets of sections will be decrypted and different files (38, 39) will be prepared.

The invention described allows an easy and convenient way for data protection, where different types of data can get a different type of protection and the type of protection can be different from one user to the other using a single generated file.

What is claimed is:

1. A system where a protection policy describing the access and usage right of users to different types of data is being prepared at a central station

2. A system where a protection policy describing the access and usage right of users to different types of data is being prepared at a user computing device

3. A method for systems according to claims 1 and 2 where file sections for encryptions are selected automatically based on a protection policy

4. A method as claim 3 where metadata is added to the encrypted sections per the file type to cause the relevant file processing application to ignore this section.

5. A method as in claim 3 where data type information is being added to the encrypted section metadata

6. A method as in claim 4 where a decryption application can decide based on the data type found in a section metadata the user type and/or the device condition if to allow decryption of the application

7. A system where a method as in claim 4 where the decryption application is being run on the user computing device

8. A system where a method as in claim 4 where there is no decryption application and the regular file processing applications will run on the file without displaying the encrypted portions

9. A method as in claim 5 where it will be decided what usage is allowed for this user type under this device conditions

10. A method as in claim 9 where the usage rights include file display, editing, printing, transferring

11. A method where specific data sections can be encrypted and marked in a sending system such that a person using a personal computing device without a special permission using a standard program will be able to use the program but not see the protected sections.

12. A method where specific data sections can be encrypted and marked in a sending system such that a person using a personal computing device with a special permission will be able to use a special program and see the protected section using a standard decryption program
